(19) United States
(12) Patent Application Publication
(10) Pub. No.: US 2021/0300219 A1
(43) Pub. Date: Sep. 30, 2021

(54) ARMREST COVER

(71) Applicants: Jay Grossman, Calabasas, CA (US); Zak Ganon, Tarzana, CA (US)

(72) Inventors: Jay Grossman, Calabasas, CA (US); Zak Ganon, Tarzana, CA (US)

(21) Appl. No.: 17/219,857

(22) Filed: Mar. 31, 2021

Related U.S. Application Data
(60) Provisional application No. 63/002,584, filed on Mar. 31, 2020.
(60) Provisional application No. 63/033,212, filed on Jun. 2, 2020.

(51) Int. Cl. B60N 2/60; B60N 2/75

(52) U.S. Cl. CPC B60N 2/6036; B60N 2/75

(57) ABSTRACT

The present system provides a cover that can be used to protect a user from existing contamination on an armrest, in particular an armrest in an airplane, bus, train, or the like. To accommodate different dimensions of armrests, the cover is such that it can be secured over a large number of sizes of armrest, by allowing it to be fastened in a variety of ways for a custom fit. In one embodiment, the cover is substantially rectangular with Velcro™ strips used to secure the cover to an armrest more tightly or loosely depending on the dimensions of the armrest.

This patent application claims priority to U.S. Provisional Patent Applications 63/002,584 filed on Mar. 31, 2020 and 63/033,212 filed on Jun. 2, 2020, both of which are incorporated by reference herein in their entirety.

### BACKGROUND OF THE SYSTEM

With the risks of infection in public places having grave consequences, consumers are looking for ways to minimize exposure to environments of unknown cleanliness. In particular, air travel has become a risky endeavor, with the potential for transmission of germs, virus, and bacteria heightened due to the close environment and heavy turnover of users. One of the risky areas of an airplane seat is the armrest between seats. Travelers often grab the seat with their bare hands to raise and lower the armrest for entrance and exit, as well as placing a hand on it for leverage to exit the seat. The seat recline button is often part of the armrest, making it a location of high skin contact, leading to contamination concerns. The same problem exists in other public transportation and public environments, namely that cleanliness of armrests is unknown and presents a risk to the user.

In the current art, people might use alcohol wipes or other disinfecting products to clean surfaces in their immediate environment. But it is difficult to know if the cleaning has been thorough enough. Another prior art solution is to wear sterile gloves during travel. However, this can be uncomfortable and can lead to dry hands if used over long periods of time. Another solution is needed.

### SUMMARY

The present system provides a cover that can be used to protect a user from existing contamination on an armrest, in particular an armrest in an airplane, bus, train, public area, or the like. To accommodate different dimensions of armrests, the cover is such that it can be secured over a large number of sizes of armrest, by allowing it to be fastened in a variety of ways for a custom fit. In one embodiment, the cover is substantially rectangular with Velcro™ strips used to secure the cover to an armrest more tightly or loosely depending on the dimensions of the armrest.

### BRIEF DESCRIPTION OF THE DRAWINGS

FIG. 1 is an illustration of a passenger seat.

FIG. 2 is an illustration of a passenger seat using an embodiment of the apparatus.

FIG. 3 is an illustration of an embodiment of the apparatus.

FIG. 4 illustrates a perspective view of an embodiment of the apparatus with pockets.

FIG. 5 is a bottom view of the apparatus of FIG. 4

FIG. 6 is a bottom view of a fastening method of an embodiment of the cover.

FIG. 7 is a view of the cover of FIG. 6 when the cover is fastened.

FIG. 8 is an embodiment of a fastening means of an embodiment of the cover.

### DETAILED DESCRIPTION OF THE SYSTEM

FIG. 1 is an illustration of a passenger seat 100. The passenger seat 100 may be in a plane, train, bus, or any other form of public transportation. In addition, the seat 100 may be in a movie theatre, stage theatre, restaurant, transportation terminal, or any other place where public exposure to an armrest may be a problem. For purposes of example, the armrest is discussed in connection with a passenger seat, but it I understood it has equal application to any seat or arm rest that presents a problem for a user.

The passenger seat 100 comprises a seat back 101, seat 102, and armrest 103. The armrest 103 may rotate up and down for entry and egress from the seat 100. The armrest 103 is handled physically quite often, often with exposed hands, by passengers, attendants, cleaning crew, maintenance crew, and the like, resulting in an increased risk of contamination.

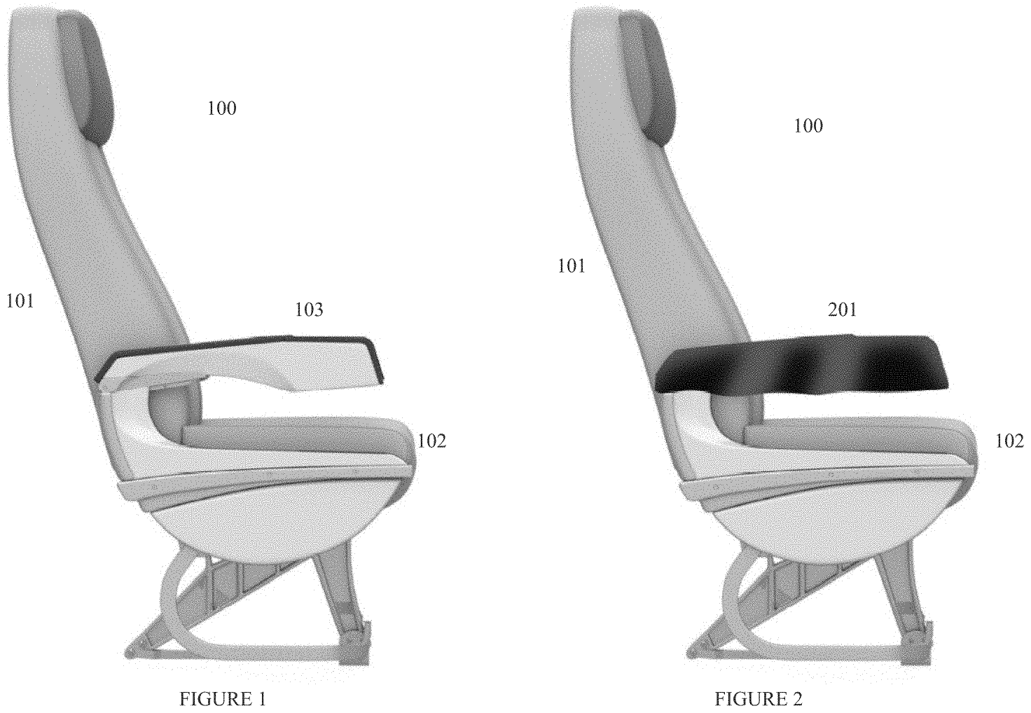

FIG. 2 illustrates the seat of FIG. 1 with an embodiment of the apparatus of the present application in place. The seat 100 includes an armrest cover 201 placed over the armrest 103. The cover 201 prevents direct contact with the potentially contaminated surface of the armrest by a user. In addition, the cover 201 is only handled by the passengers themselves, so that unknown contaminants are avoided during travel.

The cover 201 may be comprised of a sanitary material which may be stretchy, with integrated elastic, so that the cover 201 may easily be used with a variety of armrest types and dimensions. The material of the cover 201 is washable and reusable by the traveller.

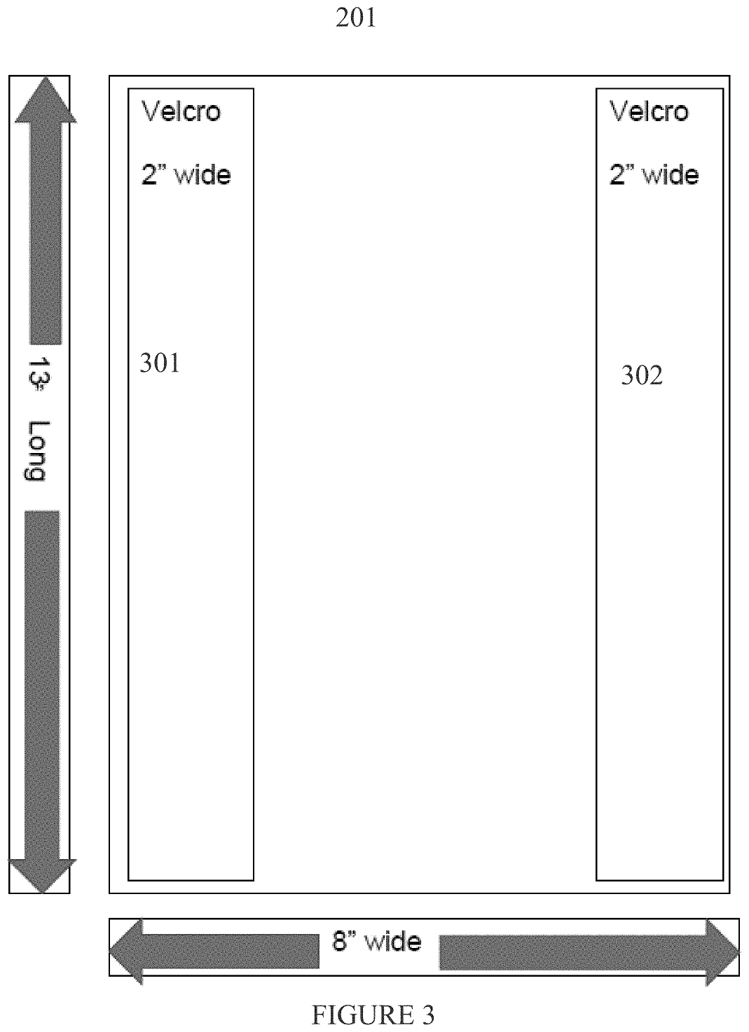

FIG. 3 is an embodiment of the cover 201 of the present application. The cover 201 comprises a rectangle of material that includes Velcro strips 301 and 302 on either of the long sides of the rectangle. One of the Velcro strips is of the “hook” type and the other is of the “loop” type. The cover 201 is wrapped around an armrest and the Velcro strips are engaged to hold the cover in place. In one embodiment, the cover 201 is 8 inches wide by 13 inches long, which may accommodate most armrests.

In one embodiment, the perimeter of the cover 201 may have an elastic band sewn in to create a shower cap effect that allows the cover 201 to be stretched over an armrest and stay in place. In one embodiment, the Velcro strips are in the form of two or more straps that can be fastened around an armrest to help hold the cover in place.

In one embodiment, the cover may be somewhat teardrop shaped to account for an armrest that is wider at one end and narrower at another end. In one embodiment, the cover is like a stocking that slips over the armrest.

Pockets

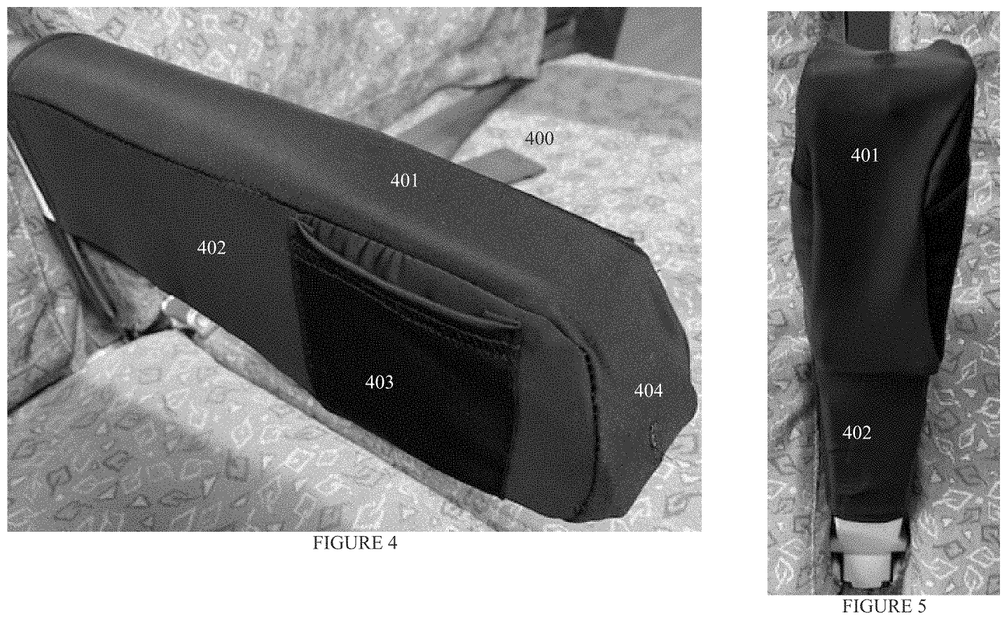

FIG. 4 illustrates an embodiment of the armrest cover with pockets. Cover 400 is a multi-member assembly including a top member 401 and two corresponding side members 402 (other side not shown in this Figure) stitched or fastened together. This configuration can be made to match the contours of an armrest more closely, with the top member having a width slightly larger than the width of a typical armrest. The side member 402 has a depth slight larger than the depth of a typical armrest. The members are shaped and assembled such as to make it relative form fitting for a tight fit over an armrest. The top member 401 may also include padding (gel, foam, sponge, filler, and the like) to provide a softer feel than a typical armrest.

Cover 400 includes a pocket 403 attached to side member 402. There may be a corresponding pocket attached to the other side member. More than one pocket may be attached per side as desired. The pockets may be sized to be wide enough to hold a typical smartphone in place during travel. Opening 404 formed in the front of top member 401 is an opening for power cords, USB and other connectors, ear buds and the like. In one embodiment there are buttonhole style openings in or near the pockets so that a smartphone or other device can be plugged in while inserted into the pocket.

Referring to the bottom view of FIG. 5, in one embodiment the top member 401 extends around the front of the armrest and continues to the bottom side. The side member 402 also extends around the bottom of the armrest so that the cover 400 is somewhat like a tube that can be slid over the armrest. The material of the cover 400 may be a stretchy or elastic material that helps hold the cover in place during use.

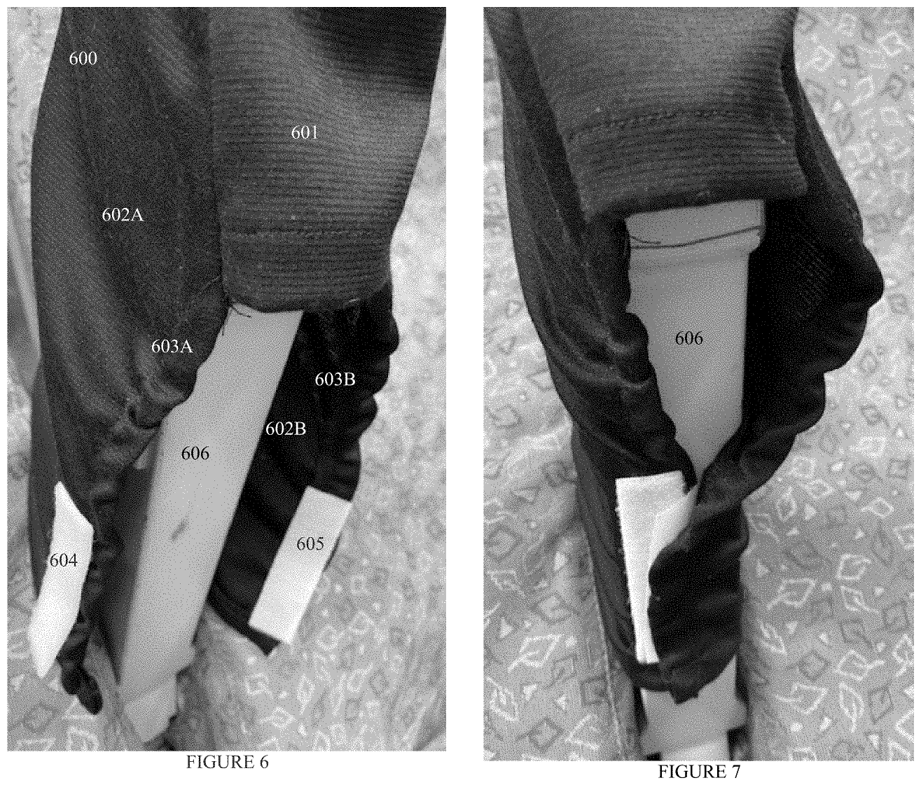

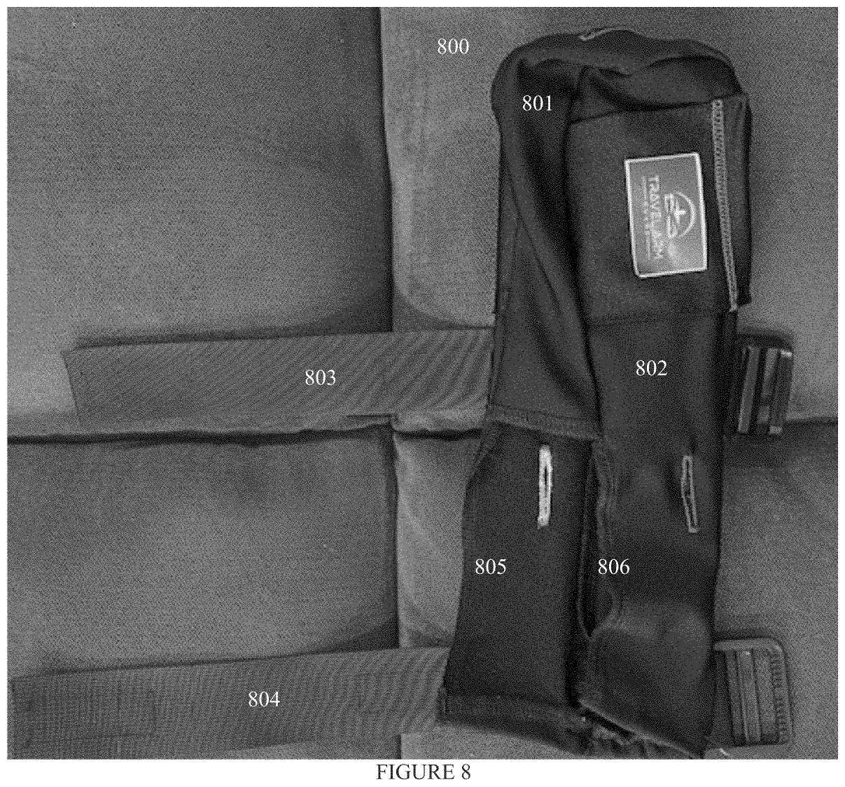

FIG. 6 is a bottom view of the fastening mechanism of an embodiment of the cover. The cover 600 has a center member 601 and side members 602A and 602B which slip over the arm of an armrest 606. The side members 602A and 602B include elastic hem 603A and 603B to allow the cover 600 to fit over a variety of sizes of armrests. Side member 602A has a Velcro pad 604 and side member 602B has a Velcro pad 605 which can be used to fasten the cover to an armrest 606 as shown in FIG. 7. The Velcro pads allow the fit to be customized for different dimensions of armrests.

FIG. 8 illustrates a fastening means in an embodiment of the cover. The cover 800 includes a first member 801 that defines a shape that slips over the end of an armrest. A side member 802 extends further to cover the rear of the armrest. Straps 803 and 804 can then be engaged to wrap around the armrest and tightened to a desired level to keep the armrest in place. The straps are spaced apart to allow the cover to fit over and be attached to an armrest that has a vertical member attached to the armrest in a T configuration.

In one embodiment, the straps could be replaced with a Velcro pad in region 805 which engages a Velcro pad at region 806.

The cover can be comprised of a stretchy material such as lycra, spandex, or the like to allow it to fit snugly over different armrests. The material is washable and breathable. The padding in the top of the cover may be memory foam, memory gel, or some other suitable padding.

Thus, an improved armrest cover has been described.

What is claimed is:

1. A cover for an armrest comprising:
a top member coupled to first and second side members, wherein the top member is disposed on an upper surface of the armrest;
the first and second side members disposed to wrap around side surfaces of the armrest and meet below the level of the armrest;
fastening means coupled to the first and second side members for securing the first and second side members together to retain the cover on the armrest.

2. The cover of claim 1 further including an opening formed in the top member for receiving a device cord.

3. The cover of claim 1 wherein the fastening means comprises Velcro™.

4. The cover of claim 1 wherein the fastening means comprises at least one strap for coupling the first side member to the second side member.

5. The cover of claim 1 wherein the top member includes a cushioning material therein.

6. The cover of claim 5 wherein the cushioning material comprises memory foam.

7. The cover of claim 5 wherein the cushioning material comprises gel.

8. The cover of claim 1 wherein the top member and the first and second side members are comprised of Spandex.

9. The cover of claim 1 further including at least one pocket formed on one of the first and second side members.
